(19) United States
(12) Patent Application Publication
(10) Pub. No.: US 2024/0087328 A1
(43) Pub. Date: Mar. 14, 2024

(54) MONITORING APPARATUS, MONITORING SYSTEM, MONITORING METHOD, AND NON-TRANSITORY COMPUTER-READABLE MEDIUM STORING PROGRAM

(71) Applicant: NEC Corporation, Minato-ku, Tokyo (JP)

(72) Inventor: Yoshihiro Kajiki, Tokyo (JP)

(73) Assignee: NEC Corporation, Minato-ku, Tokyo (JP)

(21) Appl. No.: 18/274,198

(22) PCT Filed: Jul. 20, 2021
(86) PCT No.: PCT/JP2021/027118

§ 371 Date: Jul. 25, 2023

(51) Int. Cl. G06V 20/52; G06V 20/40; G06V 40/16

(52) U.S. Cl. CPC G06V 20/53; G06V 20/44; G06V 40/174

(57) ABSTRACT

Provided is a new technique in which the severity of an occurred abnormal situation can be learned. A monitoring apparatus (1) includes: a position acquisition unit (2) configured to acquire an occurrence position of an abnormal situation in a monitoring target area; an analysis unit (3) configured to analyze a state of a crowd around the occurrence position of the abnormal situation based on video data of a camera that images the monitoring target area; and a severity estimation unit (4) configured to estimate a severity of the abnormal situation based on a result of the analysis.

### TECHNICAL FIELD

The present disclosure relates to a monitoring apparatus, a monitoring system, a monitoring method, and a non-transitory computer-readable medium storing a program.

### BACKGROUND ART

Recently, crimes such as terrorism, assault, or molestation have increased in public, for example, in the street, in a station, or in a train. On the other hand, unmanned monitoring has progressed due to labor shortage, and there are many places that cannot be manually monitored. In order to compensate for this problem, there is a monitoring method of providing a security camera, a microphone, or the like such that a video, a sound or the like that is acquired is analyzed by a program to detect abnormality (for example, Patent Literature 1).

In general, in a case where abnormality is detected from a video, as described in Patent Literature 1, video data of a monitoring camera is collected via a network and is analyzed by a computer. In the video analysis, video features relating to a risk, for example, a face image of a specific person, abnormal behaviors of a single person or a plurality of people, or an object that leaves in a specific location are registered in advance, and the presence of the features are detected.

In addition, in addition to the video, abnormality detection by a sound is also executed as in Patent Literature 1. In the sound analysis, voice recognition of recognizing and analyzing the utterance content of a person and acoustic analysis of analyzing a sound other than a voice are present, and these methods do not require much computer resources. Therefore, for example, a CPU (Central Processing Unit) embedded in, for example, a smartphone can sufficiently analyze a sound in real time.

The detection of the occurrence of an abnormal situation by the sound analysis is also effective for an unexpected abnormal situation. This is because, by universal natural law, a person who encounters an abnormal situation screams or shouts or a large abnormal sound such as explosion, blast, gunfire, or glass breakage may be generated during an abnormal situation.

In addition, a sound is diffused in all directions of 360 degrees, propagates even in the dark, and, even if there is an obstacle halfway, has a property of going around the obstacle. Therefore, in the case of sound monitoring, a monitoring target is not limited by a field of view, a direction, or a lighting unlike a camera, and there is an excellent characteristic suitable for monitoring in that an abnormal sound generated from the darkness or the shadows is not missed out.

Further, when sounds are collected from a plurality of microphones, as disclosed in Patent Literature 2, the position of a sound source can be estimated based on a difference between arrival times of sounds from the sound source to the microphones, a difference in sound pressure generated by diffusion and attenuation of the sounds, and the like.

In addition, Patent Literature 3 discloses a technique called line-of-sight estimation in which the direction of a line of sight is estimated from a face image of a person.

In addition, Patent Literature 4 discloses a technique called facial expression recognition in which a facial expression is recognized from a face image of a person.

### CITATION LIST

### Patent Literature

Patent Literature 1: Japanese Unexamined Patent Application Publication No. 2013-131153
Patent Literature 2: Published Japanese Translation of PCT International Publication for Patent Application, No. 2013-545382
Patent Literature 3: Japanese Unexamined Patent Application Publication No. 2021-61048
Patent Literature 4: International Patent Publication No. WO 2019/102619

### SUMMARY OF INVENTION

### Technical Problem

Incidentally, with the abnormality detection by a sound, a high possibility of occurrence of some abnormal situation can be grasped, but the severity of the situation cannot be grasped. As in a case where a person listens carefully with eyes closed, the abnormality detection by a sound can recognize a high possibility of occurrence of an abnormal situation from a sound such as a scream or an explosion sound but cannot grasp more detailed circumstances. Accordingly, it is difficult to grasp the severity of a situation from a sound, for example, whether the abnormality is an abnormality for which a security guard should be urgently dispatched or a minor abnormality that can be checked after waiting until the next day.

Accordingly, one object to be achieved by an example embodiment disclosed in the present specification is to provide a new technique in which the severity of an occurred abnormal situation can be learned.

### Solution to Problem

A monitoring apparatus according to a first aspect of the present disclosure includes:
position acquisition means for acquiring an occurrence position of an abnormal situation in a monitoring target area;
analysis means for analyzing a state of a crowd around the occurrence position of the abnormal situation based on video data of a camera that images the monitoring target area; and
severity estimation means for estimating a severity of the abnormal situation based on a result of the analysis.

A monitoring system according to a second aspect of the present disclosure includes:
a camera configured to image a monitoring target area;
a sensor configured to detect a sound or heat generated from the monitoring target area; and
a monitoring apparatus,
in which the monitoring apparatus includes
position acquisition means for acquiring an occurrence position of an abnormal situation in the monitoring target area by estimating a generation source of a sound or heat that is detected by the sensor,
analysis means for analyzing a state of a crowd around the occurrence position of the abnormal situation based on video data of the camera, and
severity estimation means for estimating a severity of the abnormal situation based on a result of the analysis.

A monitoring method according to a third aspect of the present disclosure includes:
acquiring an occurrence position of an abnormal situation in a monitoring target area;
analyzing a state of a crowd around the occurrence position of the abnormal situation based on video data of a camera that images the monitoring target area; and
estimating a severity of the abnormal situation based on a result of the analysis.

A program according to a fourth aspect of the present disclosure causes a computer to execute:
a position acquisition step of acquiring an occurrence position of an abnormal situation in a monitoring target area;
an analysis step of analyzing a state of a crowd around the occurrence position of the abnormal situation based on video data of a camera that images the monitoring target area; and
a severity estimation step of estimating a severity of the abnormal situation based on a result of the analysis.

### Advantageous Effects of Invention

According to the present disclosure, it is possible to provide a new technique in which the severity of an occurred abnormal situation can be learned.

### BRIEF DESCRIPTION OF DRAWINGS

FIG. 1 is a block diagram showing an example of a configuration of a monitoring apparatus according to an outline of an example embodiment;

FIG. 2 is a flowchart showing an example of the flow of an operation of the monitoring apparatus according to the outline of the example embodiment;

FIG. 3 is a schematic diagram showing an example of a configuration of a monitoring system according to an example embodiment;

FIG. 4 is a block diagram showing an example of a functional configuration of an acoustic sensor;

FIG. 5 is a block diagram showing an example of a functional configuration of an analysis server;

FIG. 6 is a schematic diagram showing an example of a hardware configuration of a computer;

FIG. 7 is a flowchart showing an example of the flow of an operation of the monitoring system according to the example embodiment; and

FIG. 8 is a flowchart showing an example of the flow of a process of step S104 in the flowchart shown in FIG. 7.

### EXAMPLE EMBODIMENT

### Outline of Example Embodiment

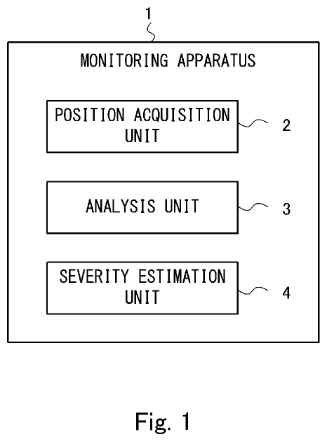

Before describing the details of an example embodiment, an outline of the example embodiment will be described. FIG. 1 is a block diagram showing an example of a configuration of a monitoring apparatus 1 according to the outline of the example embodiment. As shown in FIG. 1, the monitoring apparatus 1 is an apparatus that includes a position acquisition unit 2, an analysis unit 3, and a severity estimation unit 4 and monitors a predetermined monitoring target area.

The position acquisition unit 2 acquires an occurrence position of an abnormal situation in the monitoring target area. The position acquisition unit 2 may acquire information representing the occurrence position of the abnormal situation using any method. For example, the position acquisition unit 2 may acquire the occurrence position by estimating the occurrence position of the abnormal situation based on any information, or may acquire the occurrence position by receiving input information of the occurrence position from a user or another apparatus.

The analysis unit 3 analyzes a state of a crowd around (in the vicinity of) the occurrence position of the abnormal situation based on video data of a camera that images the monitoring target area. Here, the crowd around the occurrence position of the abnormal situation refers to, for example, not people in the occurrence position of the abnormal situation but people distant from and in the vicinity of the occurrence position. For example, the crowd corresponds to people who are distant from the occurrence position of the abnormal situation by a radius of 1 meter or more and are within a radius of 5 meters from the occurrence position. That is, the crowd around the occurrence position of the abnormal situation can also be defined as people who are distant from the occurrence position of the abnormal situation by a first predetermined distance or more and within a second predetermined distance from the occurrence position of the abnormal situation. In addition, the state of the crowd specifically refers to a state shown by the external appearances of people forming the crowd, and may be lines of sight of the people or facial expressions of the people. In this way, the analysis unit 3 analyzes the state of the crowd around the occurrence position of the abnormal situation, instead of analyzing circumstances of the occurrence position of the abnormal situation, facial features or actions of people at the occurrence position, and the like from a video of the camera.

The severity estimation unit 4 estimates a severity of the abnormal situation based on an analysis result of the analysis unit 3. In general, reactions of the crowd around the occurrence spot of the abnormal situation change depending on the severity of the abnormal situation. For example, as the severity increases, lines of sight of a large crowd of people are focused on the occurrence spot of the abnormal situation or a large crowd of people show unpleasant facial expressions. In this way, the severity estimation unit 4 of the monitoring apparatus 1 estimates severity of the abnormal situation using the universal natural law that can be shown to general animals in response to the abnormal situation.

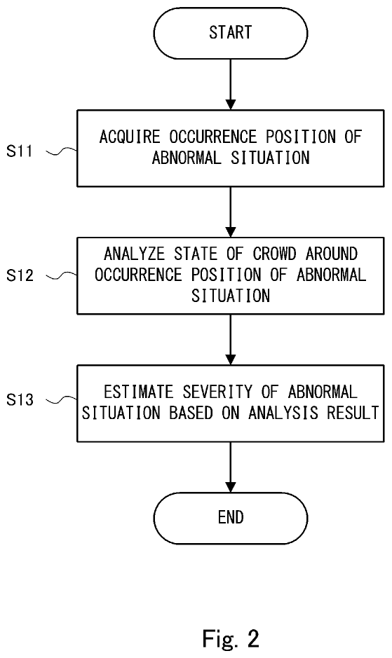

FIG. 2 is a flowchart showing an example of the flow of an operation of the monitoring apparatus 1 according to the outline of the example embodiment. Hereinafter, the example of the flow of the operation of the monitoring apparatus 1 will be described using FIG. 2.

First, in step S11, the position acquisition unit 2 acquires an occurrence position of an abnormal situation in the monitoring target area.

Next, in step S12, the analysis unit 3 analyzes a state of a crowd around the occurrence position of the abnormal situation based on video data of a camera that images the monitoring target area.

Next, in step S13, the severity estimation unit 4 estimates a severity of the abnormal situation based on a result of the analysis in step S12.

Hereinabove, the monitoring apparatus 1 according to the outline of the example embodiment has been described. In the monitoring apparatus 1, as described above, the severity of the occurred abnormal situation can be learned.

### Details of Example Embodiment

Next, the details of the example embodiment will be described.

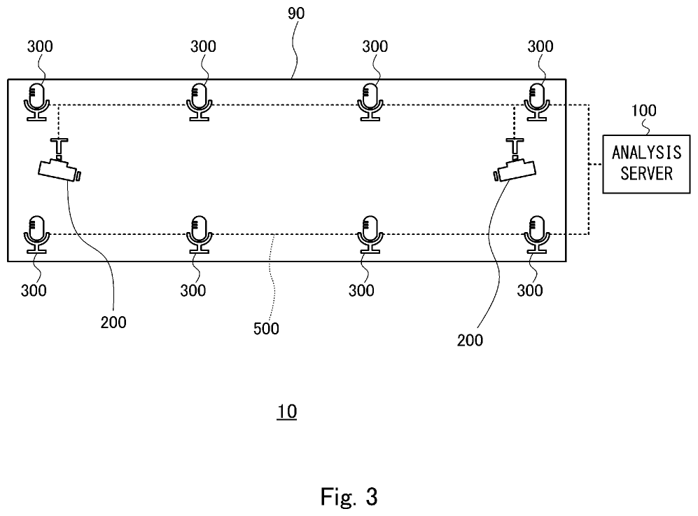

FIG. 3 is a schematic diagram showing an example of the configuration of a monitoring system 10 according to an example embodiment. In the example embodiment, the monitoring system 10 includes an analysis server 100, a monitoring camera 200, and an acoustic sensor 300. The monitoring system 10 is a system that monitors a predetermined monitoring target area 90. The monitoring target area 90 is any area to be monitored and is an area where common people may be present, for example, a station, an airport, a stadium, or a public facility.

The monitoring camera 200 is a camera that is provided to image the monitoring target area 90. The monitoring camera 200 images the monitoring target area 90 to generate video data. The monitoring camera 200 is provided at an appropriate position where the entire monitoring target area 90 can be monitored. In order to monitor the entire monitoring target area 90, a plurality of monitoring cameras 200 may be provided.

In the example embodiment, the acoustic sensor 300 is provided at each of positions in the monitoring target area 90. Specifically, for example, the acoustic sensor 300 is provided at intervals of, for example, about 10 meters to 20 meters. The acoustic sensor 300 collects a sound of the monitoring target area 90 and analyzes the collected sound. Specifically, the acoustic sensor 300 is an instrument that is composed of a microphone, a sound device, a CPU, and the like and senses a sound. The acoustic sensor 300 collects an ambient sound using the microphone, converts the collected sound into a digital signal using the sound device, and subsequently executes acoustic analysis on the digital signal using the CPU. In this acoustic analysis, for example, an abnormal sound such as a scream, a shout, a blast sound, an explosion sound, or a glass breakage sound is detected. In the acoustic sensor 300, a function of voice recognition may be mounted. In this case, higher-performance analysis of, for example, recognizing the utterance content such as a shout and estimating the severity of the abnormal situation can be executed.

In the example embodiment, the reason why the acoustic sensor 300 is provided at each of positions in the monitoring target area 90 at intervals of about meters to 20 meters is that the plurality of acoustic sensors 300 can detect an abnormal sound generated from any position in the area. In general, a noise in a public facility or the like is at about 60 decibels. On the other hand, a scream or a shout is at about 80 to 100 decibels and a blast sound or an explosion sound is at 120 decibels or higher. However, for example, when the acoustic sensor 300 is distant from a generation position of a sound by 10 meters, even the level of an abnormal sound, which would have been at 100 decibels in the vicinity of the sound source, is attenuated to 80 decibels. Here, when the distance from the sound source to the acoustic sensor 300 is too large, it is difficult distinguish between a background noise of about 60 decibels and the attenuated abnormal sound at the position of the acoustic sensor 300. Therefore, in the example embodiment, the acoustic sensors 300 are disposed at the above-described intervals. The intervals at which the plurality of acoustic sensors 300 can detect the same abnormal sound depend on the background noise level and the performance of each of the acoustic sensors 300. Therefore, the acoustic sensors 300 do not necessarily disposed at intervals of 10 meters to 20 meters.

The analysis server 100 is a server for analyzing data obtained by the monitoring camera 200 and the acoustic sensor 300 and has the function of monitoring apparatus 1 shown in FIG. 1. The analysis server 100 receives the analysis result from the acoustic sensor 300 and optionally acquires the video data from the monitoring camera 200 to analyze the video. The analysis server 100 and the monitoring camera 200 are communicably connected via a network 500. Likewise, the analysis server 100 and the acoustic sensor 300 are communicably connected via the network 500. The network 500 is a network that transmits communication between the monitoring camera 200, the acoustic sensor 300, and the analysis server 100 and may be a wired network or a wireless network.

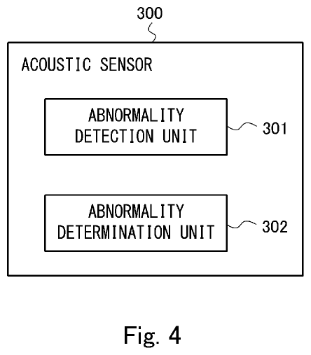

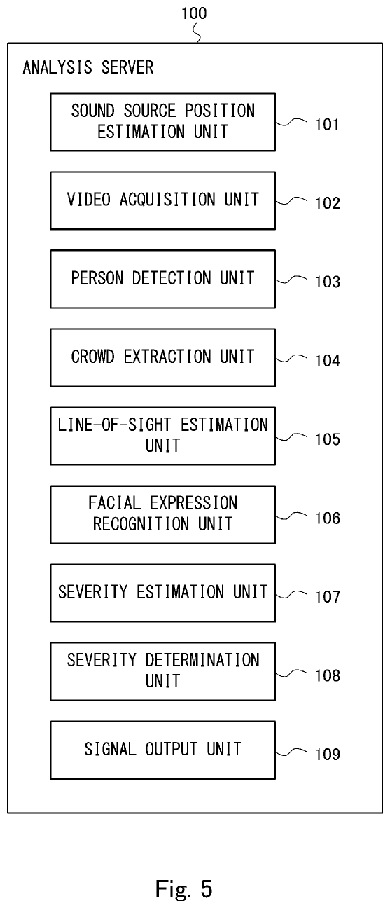

FIG. 4 is a block diagram showing an example of a functional configuration of the acoustic sensor 300. FIG. 5 is a block diagram showing an example of a functional configuration of the analysis server 100.

As shown in FIG. 4, the acoustic sensor 300 includes an abnormality detection unit 301 and an abnormality determination unit 302.

The abnormality detection unit 301 detects occurrence of an abnormal situation in the monitoring target area 90 based on the sound detected by the acoustic sensor 300. The abnormality detection unit 301 detects the occurrence of the abnormal situation, for example, by determining whether or not the sound detected by the acoustic sensor 300 corresponds to a predetermined abnormal sound. That is, when the sound detected by the acoustic sensor 300 corresponds to the predetermined abnormal sound, the abnormality detection unit 301 determines that the abnormal situation occurs in the monitoring target area 90. In addition, in the example embodiment, when the abnormality detection unit 301 determines that the abnormal situation occurs, the abnormality detection unit 301 calculates a score representing the degree of abnormality. For example, the abnormality detection unit 301 may calculate a higher score as the level of the abnormal sound increases, may calculate a score corresponding to the type of the abnormal sound, or may calculate a score using a combination of the above methods.

When the occurrence of the abnormal situation is detected, the abnormality determination unit 302 determines whether or not a countermeasure against the abnormal situation is unnecessary. For example, the abnormality determination unit 302 makes this determination by comparing the score calculated by the abnormality detection unit 301 to a preset threshold. That is, when the calculated score is the threshold or less, the abnormality determination unit 302 determines that a countermeasure against the detected abnormal situation is unnecessary. In this case, a further process in the monitoring system 10 is not executed. On the other hand, when the abnormality determination unit 302 does not determine that a countermeasure against the abnormal situation is unnecessary, the occurrence of the abnormal situation is notified from the acoustic sensor 300 to the analysis server 100. This notification process may be executed as a process of the abnormality detection unit 301. When the occurrence of the abnormal situation is notified from the acoustic sensor 300 to the analysis server 100, the process of the analysis server 100 described below is executed. In this way, in the example embodiment, whether or not to execute the process of the analysis server 100 is determined depending on the determination result of the abnormality determination unit 302. However, the process of the analysis server 100 may be executed irrespective of the determination result of the abnormality determination unit 302. That is, in all the cases where the occurrence of the abnormal situation is detected, the process of the analysis server 100 may be executed. That is, the determination process by the abnormality determination unit 302 may be skipped.

As shown in FIG. 5, the analysis server 100 includes a sound source position estimation unit 101, a video acquisition unit 102, a person detection unit 103, a crowd extraction unit 104, a line-of-sight estimation unit 105, a facial expression recognition unit 106, a severity estimation unit 107, a severity determination unit 108, and a signal output unit 109.

The sound source position estimation unit 101 estimates the occurrence position of the abnormal situation by estimating a generation source of a sound that is detected by the acoustic sensor 300 provided in the monitoring target area 90. Specifically, when the occurrence of the abnormal situation is notified from the plurality of acoustic sensors 300 to the analysis server 100, the sound source position estimation unit 101 collects acoustic data regarding the abnormal sound, for example, from the plurality of acoustic sensors 300. The sound source position estimation unit 101 estimates the sound source position of the abnormal sound, that is, the occurrence position of the abnormal situation, for example, by executing a well-known sound source position estimation process disclosed in Patent Literature 2 or the like. The sound source position estimation unit 101 corresponds to the position acquisition unit 2 shown in FIG. 1. That is, in the example embodiment, the occurrence position of the abnormal situation is acquired by estimating the generation source of the sound.

When the occurrence position of the abnormal situation is estimated by the sound source position estimation unit 101, the video acquisition unit 102 acquires video data from the monitoring camera 200 that images the estimated position. For example, the analysis server 100 stores information representing the area that is imaged by each of the monitoring cameras 200 in advance, and the video acquisition unit 102 compares the information and the estimated position to each other. As a result, the monitoring camera 200 that images the estimated position is identified.

The person detection unit 103 analyzes the video data acquired by the video acquisition unit 102 to detect people (full-length figures of the people and faces of the people). Specifically, the person detection unit 103 inputs each of frames of the video data to a multilayer neural network or the like that is learned by deep learning, and detects people in an image of each of the frames.

The crowd extraction unit 104 extracts a crowd around the occurrence position of the abnormal situation from the video data acquired by the video acquisition unit 102. That is, the crowd extraction unit 104 extracts people who are distant from and in the vicinity of the occurrence position of the abnormal situation. The crowd extraction unit 104 extracts people corresponding to the crowd among the people detected by the person detection unit 103. For example, the crowd extraction unit 104 detects a ground in the video data through an image recognition process and identifies a position where a foot of a person detected by the person detection unit 103 is in contact with the ground to estimate the position of the person in the monitoring target area 90. In addition, for example, the crowd extraction unit 104 identifies an intersection point between the ground and a straight line extending downward in the vertical direction from the position of a face detected by the person detection unit 103 to estimate the position of a person having the face in the monitoring target area 90. In addition, the crowd extraction unit 104 may estimate the position of the person based on the size of the face in the video data. The crowd extraction unit 104 extracts the crowd based on the distances between the estimated positions of the people detected by the person detection unit 103 and the occurrence position of the abnormal situation estimated by the sound source position estimation unit 101. Specifically, as the crowd around the occurrence position of the abnormal situation, the crowd extraction unit 104 extracts, for example, the people who are distant from the occurrence position of the abnormal situation by 1 meter or more and are within 5 meters from the occurrence position of the abnormal situation.

The line-of-sight estimation unit 105 estimates the line of sight of each of the people forming the crowd around the occurrence position of the abnormal situation. That is, the line-of-sight estimation unit 105 estimates the line of sight of each of the people extracted as the crowd by the crowd extraction unit 104. The line-of-sight estimation unit 105 estimates the line of sight by executing a well-known line-of-sight estimation process on the video data. For example, the line-of-sight estimation unit 105 may estimate the line of sight by executing a process disclosed in Patent Literature 3 on the face image. In addition, for a person or the like whose back side of the head is directed to the monitoring camera 200, the line-of-sight estimation unit 105 may estimate the line of sight from the direction of the head in the image. In addition, the line-of-sight estimation unit 105 may calculate a reliability (estimation accuracy) of the estimated line of sight based on the number of pixels or the like of the face or the eye portion.

The facial expression recognition unit 106 recognizes the facial expression of each of the people forming the crowd around the occurrence position of the abnormal situation. That is, the facial expression recognition unit 106 recognizes the facial expression of each of the people extracted as the crowd by the crowd extraction unit 104. The facial expression recognition unit 106 recognizes the facial expression by executing a well-known facial expression recognition process on the video data. For example, the facial expression recognition unit 106 may recognize the facial expression by executing a process disclosed in Patent Literature 4 on the face image. In particular, the facial expression recognition unit 106 determines whether or not the facial expression on the face of each of the people is a predetermined facial expression. Here, specifically, the predetermined facial expression is an unpleasant facial expression. In a case where a score value representing an emotion, for example, the degree of smiling or the degree of anger is obtained as the recognition result of the facial expression, the facial expression recognition unit 106 may determine that the facial expression each of the people is an unpleasant facial expression, for example, when the score value of the degree of smiling is a reference value or less or when the score value of the degree of anger is a reference value or more. In this way, the facial expression recognition unit 106 determines whether or not each of the facial expressions of the crowd corresponds to the facial expression of a person who recognizes the abnormal situation. In addition, the facial expression recognition unit 106 may calculate the reliability (recognition accuracy) of recognized facial expressions based on the number of people in the crowd whose faces are imaged, the number of pixels of the face of each of the people, or the like.

The severity estimation unit 107 estimates the severity of the abnormal situation based on the process results of the line-of-sight estimation unit 105 and the facial expression recognition unit 106. Specifically, the severity estimation unit 107 estimates the severity of the abnormal situation as follows based on the process result of the line-of-sight estimation unit 105. The severity estimation unit 107 estimates the severity of the abnormal situation, for example, based on the number of people whose line of sight is directed to a direction of the occurrence position of the abnormal situation in the extracted crowd or a ratio of the number of people whose line of sight is directed to a direction of the occurrence position of the abnormal situation to the number of people in the crowd. For example, as the number of people whose line of sight is directed to the direction of the occurrence position of the abnormal situation increases, the severity estimation unit 107 estimates that the severity is higher. Likewise, as the ratio of the number of people whose line of sight is directed to the direction of the occurrence position of the abnormal situation increases, the severity estimation unit 107 estimates that the severity is higher. The severity estimation unit 107 may calculate the reliability with respect to the estimated severity of the abnormal situation based on the reliability with respect to the line-of-sight estimation result of each of the people.

In addition, the severity estimation unit 107 estimates the severity of the abnormal situation as follows based on the process result of the facial expression recognition unit 106. The severity estimation unit 107 estimates the severity of the abnormal situation, for example, based on the number of people whose recognized facial expression corresponds to a predetermined facial expression or a ratio of the number of people whose recognized facial expression corresponds to a predetermined facial expression to the number of people in the crowd. For example, as the number of people whose recognized facial expression corresponds to a predetermined facial expression increases, the severity estimation unit 107 estimates that the severity is higher. Likewise, as the ratio of the number of people whose recognized facial expression corresponds to a predetermined facial expression increases, the severity estimation unit 107 estimates that the severity is higher. In addition, the severity estimation unit 107 may calculate, as the severity, a value obtained by multiplying the emotion score value such as the degree of smiling or the degree of anger by a correlation coefficient representing a correlation between the unpleasant facial expression when the person sees the abnormal situation and the emotion score value. At this time, the severity estimation unit 107 may estimate the severity of an emergency situation shown by the entire crowd by calculating the average of the severities calculated as described above from the facial expressions of the people forming the extracted crowd. The severity estimation unit 107 may calculate the reliability with respect to the estimated severity of the abnormal situation based on the reliability with respect to the facial expression recognition result of each of the people.

The severity estimation unit 107 may adopt any one of the severity estimated based on the process result of the line-of-sight estimation unit 105 or the severity estimated based on the process result of the facial expression recognition unit 106. In the example embodiment, the severity estimation unit 107 integrates both of the severities to calculate the final severity. That is, the severity estimation unit 107 integrates the severity estimated from the lines of sight of the extracted crowd and the severity estimated from the facial expressions of the extracted crowd. For example, the severity estimation unit 107 may calculate the average value of the severity estimated based on the process result of the line-of-sight estimation unit 105 and the severity estimated based on the process result of the facial expression recognition unit 106 as the final severity, or may calculate the final severity using both of the severities and the reliabilities. For example, the severity estimation unit 107 may use the reliability with respect to the severity based on the line-of-sight estimation and the reliability with respect to the severity based on the facial expression recognition as weights to calculate a weighted average of the severity based on the line-of-sight estimation and the severity based on the facial expression recognition. This method is merely exemplary of the calculation of the severity using the reliability, and the severity may be calculated using another method. For example, the entire severity may be acquired using a well-known statistics or by Bayesian estimation based on the reliability of each of the people.

The severity determination unit 108 may determine whether or not a countermeasure against the occurred abnormal situation is necessary. Specifically, the severity determination unit 108 determines whether or not the severity that is finally estimated by the severity estimation unit 107 is a predetermined threshold or more. When the severity is the predetermined threshold or more, the severity determination unit 108 determines that the countermeasure against the occurred abnormal situation is necessary. When the severity is not the predetermined threshold or more, the severity determination unit 108 determines that the countermeasure is unnecessary.

When the severity determination unit 108 determines that the countermeasure against the occurred abnormal situation is necessary, the signal output unit 109 outputs a predetermined signal for taking the countermeasure against the abnormal situation. That is, the signal output unit 109 outputs the predetermined signal when the severity is the predetermined threshold or more. The predetermined signal may be a signal for giving a predetermined instruction to another program (another apparatus) or a person. For example, the predetermined signal may be a signal for outputting an alarm lamp and an alarm sound in a guardroom or the like, or may be a message for instructing a security guard or the like to take a countermeasure against the abnormal situation. In addition, the predetermined signal may be a signal for blinking a warning lamp in the vicinity of the occurrence position of the abnormal situation to suppress criminal actions, or may be a signal for outputting a warning that urges people near the occurrence position of the abnormal situation to evacuate.

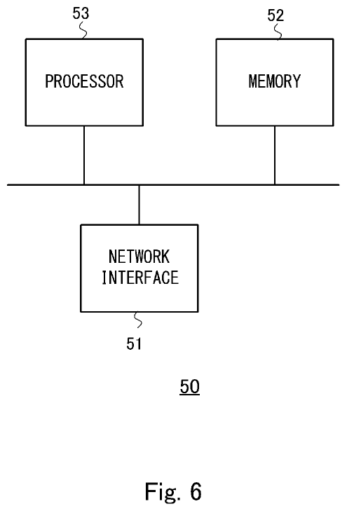

The function shown in FIG. 4 and the function shown in FIG. 5 may be implemented, for example, by a computer 50 shown in FIG. 6. FIG. 6 is a schematic diagram showing an example of a hardware configuration of the computer 50. As shown in FIG. 6, the computer 50 includes a network interface 51, a memory 52, and a processor 53.

The network interface 51 is used for communication with any another apparatus. The network interface 51 may include, for example, a network interface card (NIC).

The memory 52 is composed of, for example, a combination of a volatile memory and a nonvolatile memory. The memory 52 is used for storing a program including one or more instructions, data used for various processes, and the like that are executed by the processor 53.

The processor 53 executes the process of each of the components shown in FIG. 4 or FIG. 5 by reading the program from the memory 52 and executing the read program. The processor 53 may be, for example, a microprocessor, an MPU (Micro Processor Unit) or a CPU (Central Processing Unit). The processor 53 may include a plurality of processors.

When the program is read by the computer, the program includes instructions (or software cods) for causing the computer to execute one or more functions described in the example embodiment. The program may be stored in a non-transitory computer-readable medium or a tangible recording medium. Although not limited thereto, examples of the computer-readable medium or the tangible recording medium include a random-access memory (RAM), a read-only memory (ROM), a flash memory, a solid-state drive (SSD), or other memory techniques, a CD-ROM, a digital versatile disc (DVD), a Blu-ray (registered trade name) disc, or other optical disc storages, a magnetic cassette, a magnetic tape, a magnetic disc storage, and other magnetic storage devices. The program may be sent on a transitory computer-readable medium or a communication medium. Although not limited thereto, examples of the transitory computer-readable medium or the communication medium include electrical, optical, acoustic, or other forms of propagating signals.

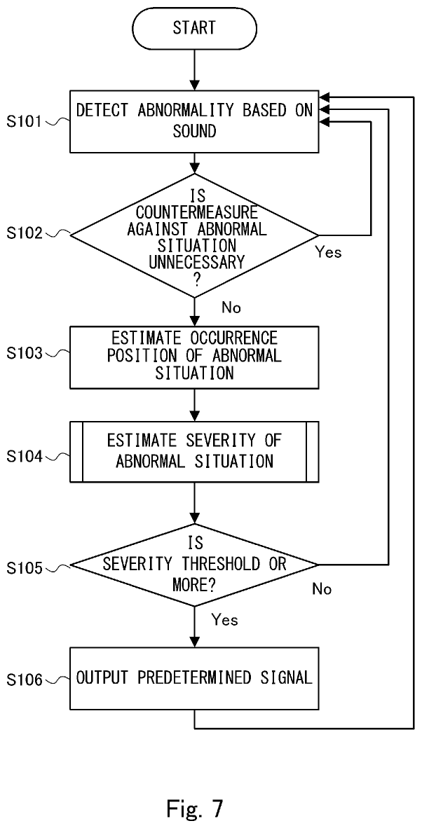

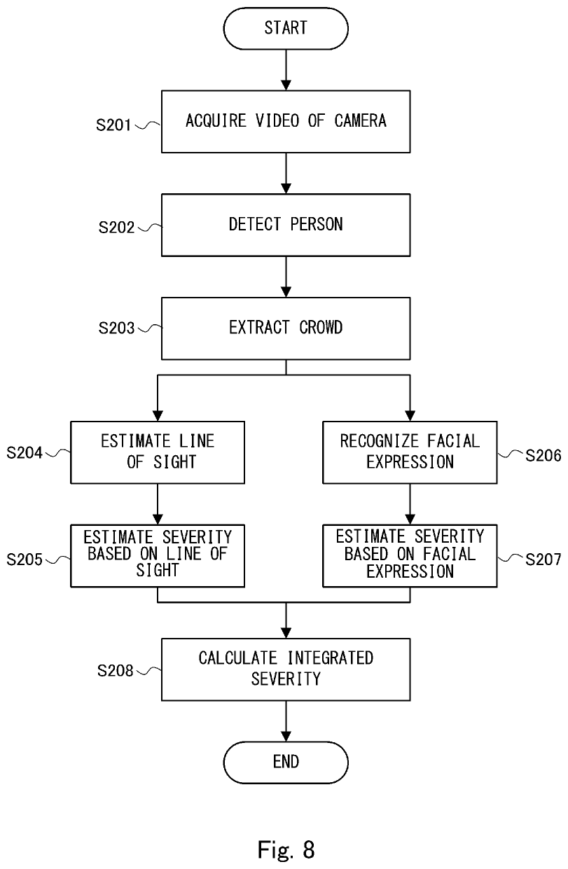

Next, the flow of the operation of the monitoring system 10 will be described. FIG. 7 is a flowchart showing an example of the flow of the operation of the monitoring system 10. In addition, FIG. 8 is a flowchart showing an example of the flow of a process of step S104 in the flowchart shown in FIG. 7. Hereinafter, the example of the flow of the operation of the monitoring system 10 will be described using FIGS. 7 and 8. In the example embodiment, step S101 and step S102 are executed as the process of the acoustic sensor 300, and the processes after step S103 are executed as the process of the analysis server 100.

In step S101, the abnormality detection unit 301 detects occurrence of an abnormal situation in the monitoring target area 90 based on the sound detected by the acoustic sensor 300.

Next, in step S102, the abnormality determination unit 302 determines whether or not a countermeasure against the abnormal situation is unnecessary. When the abnormality determination unit 302 determines that a countermeasure against the occurred abnormal situation is unnecessary (Yes in step S102), the process returns to step S101. When the abnormality determination unit 302 does not determine that a countermeasure against the occurred abnormal situation is unnecessary (No in step S102), the process proceeds to step S103.

In step S103, the sound source position estimation unit 101 estimates the occurrence position of the abnormal situation by estimating a generation source of the sound.

Next, in step S104, the estimation of the severity of the abnormal situation by video analysis is executed. In this way, the process of the video analysis is not executed at normal times and is executed only when the abnormal situation occurs. That is, the analysis process using the video of the monitoring camera 200 is executed when the occurrence of the abnormal situation is detected and is not executed before detecting the occurrence of the abnormal situation. As in the technique disclosed in Patent Literature 1, when the occurrence of the abnormal situation is detected by analyzing the video of the monitoring camera in real time, massive computer resources are required. On the other hand, in the example embodiment, as described above, the process of the video analysis is not executed at normal times and is executed only when the abnormal situation occurs. Therefore, in the example embodiment, the usage of computer resources can be suppressed.

The process of step S104 will be described in detail with reference to FIG. 8.

First, in step S201, in order to analyze the video, the video acquisition unit 102 acquires video data from the monitoring camera 200 that images the occurrence position of the abnormal situation among all of the monitoring cameras 200 provided in the monitoring target area 90. Therefore, the analysis process is executed only on the video data of the monitoring camera 200 (the monitoring camera 200 in the vicinity of the position of the sound source) that images an area including the occurrence position of the abnormal situation among the plurality of monitoring cameras 200. As described above, the detection of the occurrence of the abnormal situation is executed not by the analysis of the video but by the detection of the sound. As a result, in the example embodiment, the analysis process of the video can be reduced. Accordingly, in the example embodiment, the usage of computer resources can be further suppressed.

Next, in step S202, the person detection unit 103 analyzes the acquired video data to detect people (full-length figures of the people and faces of the people).

Next, in step S203, the crowd extraction unit 104 extracts people forming the crowd around the occurrence position of the abnormal situation among the detected people.

After step S203, the process regarding the line of sight (step S204 and step S205) and the process regarding the facial expression (step S206 and step S207) are executed in parallel. The process regarding the line of sight and the process regarding the facial expression may be sequentially executed instead of being executed in parallel.

In step S204, the line-of-sight estimation unit 105 executes the line-of-sight estimation process on the crowd around the occurrence position of the abnormal situation.

In step S205, the severity estimation unit 107 executes the estimation process of the severity of the abnormal situation based on the process result of the line-of-sight estimation unit 105.

In step S206, the facial expression recognition unit 106 executes the facial expression recognition process on the crowd around the occurrence position of the abnormal situation.

In step S207, the severity estimation unit 107 executes the estimation process of the severity of the abnormal situation based on the process result of the facial expression recognition unit 106.

After step S205 and step S207, the process proceeds to step S208. In step S208, the severity estimation unit 107 calculates the final severity obtained by integrating the severity estimated based on the process result of the line-of-sight estimation unit 105 and the severity estimated based on the process result of the facial expression recognition unit 106. After step S208, the process proceeds to step S105 shown in FIG. 7.

In step S105, the severity determination unit 108 determines whether or not the severity estimated in step S104 is a predetermined threshold or more. When the severity estimated in step S104 is less than the predetermined threshold (No in step S105), the process returns to step S101. When the severity is the predetermined threshold or more (Yes in step S105), the process proceeds to step S106.

In step S106, the signal output unit 109 outputs a predetermined signal for taking the countermeasure against the abnormal situation. After step S106, the process returns to step S101.

Hereinabove, the example embodiment has been described. In the monitoring system 10, as described above, the severity of the occurred abnormal situation can be learned.

Incidentally, when the occurrence of the abnormality is detected by analyzing the video, it is necessary to define features of the video corresponding to the abnormality in advance. That is, in order to detect the occurrence of the abnormal situation from the video, after defining video features for various abnormal situations in advance, a program for the analysis (for example, a program for generating a classifier by machine learning) needs to be prepared. However, in the real world, facial features, belongings, actions of crime suspects or victims are various, and various crimes and accidents occur. Therefore, unless some preconditions are attached, it is difficult to define video features corresponding to the abnormal situation in advance, and the method of detecting the occurrence of abnormal situation from a video is deficient in practicability. For example, Patent Literature 1 discloses an example where a face image of a specific person is registered in advance. However, face images of all the people who cause an unexpected abnormal situation are not collected in advance. Therefore, the usage of abnormality detection where face images or facial features are video features is limited. In addition, Patent Literature 1 also discloses an example where abnormal behaviors of a single person or a plurality of people are registered in advance. However, for example, there is little difference between a video where a plurality of people are gathered and are fighting and a video where a plurality of drunken people are excited and make a noise, and it is difficult to detect the occurrence of an abnormal situation from the video. In this way, in the video analysis, unless some preconditions are attached, appropriate analysis is difficult to execute.

On the other hand, in the example embodiment, the occurrence of the abnormal situation is detected using a method other than the video analysis. The analysis of the crowd in the video is executed under the precondition that the occurrence of the abnormal situation is already detected. For example, when a street musician or a street performer makes a performance, there is a scene where, although an abnormal situation does not occur, the line of sight of the crowd around a certain person is focused on the person. In addition, for example, when a politician who is not supported by citizens makes a speech in the street, there is also a scene where, although an abnormal situation does not occur, the crowd around the position shows an unpleasant facial expression. Accordingly, the line of sight or the facial expression of the crowd can be analyzed, but the occurrence of the abnormal situation cannot be determined. On the other hand, under a precondition that the occurrence of an abnormal situation such as a criminal action or accident is detected using any method, a line of sight, a facial expression, or the like functions effectively as a video feature based on which the severity of the abnormal situation is measured. The reason for this is that the state of the crowd who encounters the abnormal situation is likely to comply with the universal natural law that can be shown to general animals. In this way, with the example embodiment, a practical monitoring system can be provided.

In addition, in the example embodiment, as the analysis of the state of the crowd, whether or not the lines of sight of the crowd are directed to the direction of the occurrence position of the abnormal situation is analyzed. The reason for this is that the example embodiment is based on the natural law in which, when an abnormal situation such as a criminal action or accident occurs, the crowd has a doubt about what's happening?, a rescue is necessary, and the risk also affects myself, and the lines of sight are likely to be directed to the direction of the occurrence position of the abnormal situation. As disclosed in Patent Literature 3 or the like, a technique of estimating the direction of the line of sight from an image acquired from a video such as a monitoring camera video that is acquired from a slightly distant position is already established. Therefore, whether or not the lines of sight of the crowd are directed to the direction of the occurrence position of the abnormal situation can be analyzed with high accuracy using the existing technique.

In addition, in the example embodiment, as the analysis of the state of the crowd, whether or not the facial expressions of the crowd are unpleasant facial expressions is analyzed. The reason for this is that the example embodiment is based on the natural law in which, when an abnormal situation such as a criminal action or accident occurs, the crowd are likely to feel unpleasant in response to the abnormal situation, to stop smiling, and to show a unpleasant facial expression such as knitting of the brows. As disclosed in Patent Literature 4 or the like, a technique of recognizing a facial expression of a person from an image acquired from a video such as a monitoring camera video that is acquired from a slightly distant position and estimating an emotion such as the degree of smiling or the degree of anger from the facial expression is already established. Therefore, whether or not the facial expressions of the crowd are unpleasant facial expressions can be analyzed with high accuracy using the existing technique.

In addition, in the example embodiment, the occurrence of the abnormal situation is detected by a sound. As described above, a sound has excellent characteristics suitable for monitoring, and by using a sound, even an unexpected abnormal situation can be detected with high accuracy. In the abnormality detection by a sound, there is a problem in that the severity of the situation cannot be grasped. However, in the example embodiment, the severity is estimated by analyzing the state of the crowd around the occurrence position of the abnormal situation. Therefore, in the example embodiment, by using the abnormality detection by a sound and the estimation of the severity by a video of the crowd in combination, the difficulty of the detection of the occurrence of the abnormal situation by the video and the difficulty of the determination of the severity of the abnormal situation by a sound are conquered.

In addition, in the example embodiment, the occurrence position of the abnormal situation is estimated by a sound. The sound source position can be identified based on a difference between the arrival times of sounds at the plurality of microphones or a difference between sound pressures. Therefore, the estimation of the occurrence position of the abnormal situation can be easily implemented. As described above, a sound is also suitable for the detection of the abnormal situation. Therefore, by detecting a sound, not only the detection of the abnormal situation but also the estimation of the position thereof can be executed. Therefore, by using the detection of the abnormal situation and the estimation of the position by a sound in combination, the detection of a sound can be efficiently utilized.

In addition, in the example embodiment, as described above, the process of the video analysis is not executed at normal times and is executed only when the abnormal situation occurs. Therefore, in the example embodiment, the usage of computer resources can be suppressed. As described above, the analysis process is executed only on the video data of the monitoring camera 200 that images an area including the occurrence position of the abnormal situation among the plurality of monitoring cameras 200. Therefore, in the example embodiment, the usage of computer resources can be further suppressed.

### Modification Example of Example Embodiment

In the above-described example embodiment, the acoustic sensor 300 is disposed, and the acoustic sensor 300 includes the abnormality detection unit 301 and the abnormality determination unit 302. Instead of this configuration, a monitoring system having the following configuration may be adopted. That is, a microphone may be disposed in the monitoring target area 90 instead of the acoustic sensor 300, a voice signal collected by the microphone may be transmitted to the analysis server 100, and the analysis server 100 may execute acoustic analysis or voice recognition thereon. That is, at least the microphone among the components of the acoustic sensor 300 may be disposed in the monitoring target area 90, and the other components do not need to be disposed in the monitoring target area 90. In this way, the above-described processes of the abnormality detection unit 301 and the abnormality determination unit 302 may be implemented by the analysis server 100.

In addition, the acoustic sensor 300 in FIG. 3 can also be replaced with another sensor. When high heat is generated by an abnormal situation to be monitored, for example, during the use of a gun or the use of a bomb, a sensor such as an infrared sensor or an infrared camera that detects a high temperature may be used. In the case of the infrared camera, a high-temperature generation position can be estimated from an image even without disposing a plurality of sensors. In addition, this sensor or camera may be used in combination with the acoustic sensor, and the combination can also be selected depending on installation locations or the like. Accordingly, the occurrence of the abnormal situation may be detected based on a sound or heat that is detected by a sensor provided in the monitoring target area, and the occurrence position of the abnormal situation may be acquired by estimating a generation source of a sound or heat that is detected by a sensor provided in the monitoring target area. The monitoring method according to the above-described example embodiment may be implemented and commercially available as a monitoring program. In this case, a user can use this monitoring method by installing the program on any hardware. Therefore, the convenience is improved. In addition, the monitoring method according to the above-described example embodiment may be implemented as a monitoring apparatus. In this case, a user itself prepares the hardware such that the above-described monitoring method can be used without making an effort to install the program. Therefore, the convenience is improved. In addition, the monitoring method according to the above-described example embodiment may be implemented as a system composed of a plurality of the apparatuses. In this case, a user can use the above-described monitoring method without making an effort to adjust a combination of a plurality of apparatuses.

Hereinabove, the present invention has been described with reference to the example embodiment. However, the present invention is not limited to the above-described example embodiment. For the configuration or the details of the present invention, various changes that can be understood by those skilled in the art can be made within the scope of the invention.

A part or the entirety of the example embodiment can also be described in the following Supplementary Notes, but the present disclosure is not limited thereto.

### (Supplementary Note 1)

A monitoring apparatus including:
position acquisition means for acquiring an occurrence position of an abnormal situation in a monitoring target area;
analysis means for analyzing a state of a crowd around the occurrence position of the abnormal situation based on video data of a camera that images the monitoring target area; and
severity estimation means for estimating a severity of the abnormal situation based on a result of the analysis.

### (Supplementary Note 2)

In the monitoring system according to Supplementary Note 1, as the analysis of the state of the crowd, the analysis means estimates a line of sight of each of people forming the crowd and analyzes the number of people whose line of sight is directed to a direction of the occurrence position of the abnormal situation or a ratio of the number of people whose line of sight is directed to a direction of the occurrence position of the abnormal situation to the number of people in the crowd.

### (Supplementary Note 3)

In the monitoring apparatus according to Supplementary Note 1 or 2, as the analysis of the state of the crowd, the analysis means recognizes a facial expression of each of people forming the crowd and analyzes the number of people whose recognized facial expression corresponds to a predetermined facial expression or a ratio of the number of people whose recognized facial expression corresponds to the predetermined facial expression to the number of people in the crowd.

### (Supplementary Note 4)

In the monitoring apparatus according to any one of Supplementary Notes 1 to 3, the position acquisition means acquires the occurrence position of the abnormal situation by estimating a generation source of a sound or heat that is detected by a sensor provided in the monitoring target area.

### (Supplementary Note 5)

In the monitoring apparatus according to any one of Supplementary Notes 1 to 4, an analysis process by the analysis means is executed when the occurrence of the abnormal situation is detected and is not executed before detecting the occurrence of the abnormal situation.

### (Supplementary Note 6)

In the monitoring apparatus according to Supplementary Note 5, the monitoring apparatus further includes abnormality detection means for detecting the occurrence of the abnormal situation based on a sound or heat that is detected by a sensor provided in the monitoring target area.

### (Supplementary Note 7)

In the monitoring apparatus according to any one of Supplementary Notes 1 to 6, the analysis means executes an analysis process on only video data of a camera that images an area including the occurrence position of the abnormal situation among a plurality of the cameras.

### (Supplementary Note 8)

In the monitoring apparatus according to any one of Supplementary Notes 1 to 7, the monitoring apparatus further includes:
severity determination means for determining whether or not the severity is a predetermined threshold or more; and
signal output means for outputting a predetermined signal when the severity is the predetermined threshold or more.

### (Supplementary Note 9)

A monitoring system including:
a camera configured to image a monitoring target area;
a sensor configured to detect a sound or heat generated from the monitoring target area; and
a monitoring apparatus,
in which the monitoring apparatus includes
position acquisition means for acquiring an occurrence position of an abnormal situation in the monitoring target area by estimating a generation source of a sound or heat that is detected by the sensor,
analysis means for analyzing a state of a crowd around the occurrence position of the abnormal situation based on video data of the camera, and
severity estimation means for estimating a severity of the abnormal situation based on a result of the analysis.

### (Supplementary Note 10)

In the monitoring system according to Supplementary Note 9, as the analysis of the state of the crowd, the analysis means estimates a line of sight of each of people forming the crowd and analyzes the number of people whose line of sight is directed to a direction of the occurrence position of the abnormal situation or a ratio of the number of people whose line of sight is directed to a direction of the occurrence position of the abnormal situation to the number of people in the crowd.

### (Supplementary Note 11)

In the monitoring system according to Supplementary Note 9 or 10, as the analysis of the state of the crowd, the analysis means recognizes a facial expression of each of people forming the crowd and analyzes the number of people whose recognized facial expression corresponds to a predetermined facial expression or a ratio of the number of people whose recognized facial expression corresponds to the predetermined facial expression to the number of people in the crowd.

### (Supplementary Note 12)

A monitoring method including:
acquiring an occurrence position of an abnormal situation in a monitoring target area;
analyzing a state of a crowd around the occurrence position of the abnormal situation based on video data of a camera that images the monitoring target area; and
estimating a severity of the abnormal situation based on a result of the analysis.

### (Supplementary Note 13)

A non-transitory computer-readable medium storing a program that causes a computer to execute:
a position acquisition step of acquiring an occurrence position of an abnormal situation in a monitoring target area;
an analysis step of analyzing a state of a crowd around the occurrence position of the abnormal situation based on video data of a camera that images the monitoring target area; and
a severity estimation step of estimating a severity of the abnormal situation based on a result of the analysis.

### REFERENCE SIGNS LIST

1 MONITORING APPARATUS
2 POSITION ACQUISITION UNIT
3 ANALYSIS UNIT
4 SEVERITY ESTIMATION UNIT
10 MONITORING SYSTEM
50 COMPUTER
51 NETWORK INTERFACE
52 MEMORY
53 PROCESSOR
90 MONITORING TARGET AREA
100 ANALYSIS SERVER
101 SOUND SOURCE POSITION ESTIMATION UNIT
102 VIDEO ACQUISITION UNIT
103 PERSON DETECTION UNIT
104 CROWD EXTRACTION UNIT
105 LINE-OF-SIGHT ESTIMATION UNIT
106 FACIAL EXPRESSION RECOGNITION UNIT
107 SEVERITY ESTIMATION UNIT
108 SEVERITY DETERMINATION UNIT
109 SIGNAL OUTPUT UNIT
200 MONITORING CAMERA
300 ACOUSTIC SENSOR
301 ABNORMALITY DETECTION UNIT
302 ABNORMALITY DETERMINATION UNIT
500 NETWORK

What is claimed is:

1. A monitoring apparatus comprising:
at least one memory storing instructions; and
at least one processor configured to execute the instructions to:
acquire an occurrence position of an abnormal situation in a monitoring target area;
analyze a state of a crowd around the occurrence position of the abnormal situation based on video data of a camera that images the monitoring target area; and
estimate a severity of the abnormal situation based on a result of the analysis.

2. The monitoring apparatus according to claim 1, wherein the processor is configured to execute the instructions to, as the analysis of the state of the crowd, estimate a line of sight of each of people forming the crowd and analyze the number of people whose line of sight is directed to a direction of the occurrence position of the abnormal situation or a ratio of the number of people whose line of sight is directed to a direction of the occurrence position of the abnormal situation to the number of people in the crowd.

3. The monitoring apparatus according to claim 1, wherein the processor is configured to execute the instructions to, as the analysis of the state of the crowd, recognize a facial expression of each of people forming the crowd and analyze the number of people whose recognized facial expression corresponds to a predetermined facial expression or a ratio of the number of people whose recognized facial expression corresponds to the predetermined facial expression to the number of people in the crowd.

4. The monitoring apparatus according to claim 1, wherein the processor is configured to execute the instructions to acquire the occurrence position of the abnormal situation by estimating a generation source of a sound or heat that is detected by a sensor provided in the monitoring target area.

5. The monitoring apparatus according to claim 1, wherein an analysis process for the analyzing the state of the crowd is executed when the occurrence of the abnormal situation is detected and is not executed before detecting the occurrence of the abnormal situation.

6. The monitoring apparatus according to claim 5, wherein the processor is further configured to execute the instructions to detect the occurrence of the abnormal situation based on a sound or heat that is detected by a sensor provided in the monitoring target area.

7. The monitoring apparatus according to claim 1, wherein, in the analyzing the state of the crowd, an analysis process on only video data of a camera that images an area including the occurrence position of the abnormal situation among a plurality of the cameras is executed.

8. The monitoring apparatus according to claim 1, wherein the processor is further configured to execute the instructions to:
determine whether or not the severity is a predetermined threshold or more; and
output a predetermined signal when the severity is the predetermined threshold or more.

9.-11. (canceled)

12. A monitoring method comprising:
acquiring an occurrence position of an abnormal situation in a monitoring target area;
analyzing a state of a crowd around the occurrence position of the abnormal situation based on video data of a camera that images the monitoring target area; and
estimating a severity of the abnormal situation based on a result of the analysis.

13. A non-transitory computer-readable medium storing a program that causes a computer to execute:
a position acquisition step of acquiring an occurrence position of an abnormal situation in a monitoring target area;
an analysis step of analyzing a state of a crowd around the occurrence position of the abnormal situation based on video data of a camera that images the monitoring target area; and
a severity estimation step of estimating a severity of the abnormal situation based on a result of the analysis.

14. The monitoring method according to claim 12, wherein the analyzing the state of the crowd comprises:
estimating a line of sight of each of people forming the crowd; and
analyzing the number of people whose line of sight is directed to a direction of the occurrence position of the abnormal situation or a ratio of the number of people whose line of sight is directed to a direction of the occurrence position of the abnormal situation to the number of people in the crowd.

15. The monitoring method according to claim 12, wherein the analyzing the state of the crowd comprises:
recognizing a facial expression of each of people forming the crowd; and
analyzing the number of people whose recognized facial expression corresponds to a predetermined facial expression or a ratio of the number of people whose recognized facial expression corresponds to the predetermined facial expression to the number of people in the crowd.

16. The monitoring method according to claim 12, wherein the occurrence position of the abnormal situation is acquired by estimating a generation source of a sound or heat that is detected by a sensor provided in the monitoring target area.

17. The monitoring method according to claim 12, wherein an analysis process for the analyzing the state of the crowd is executed when the occurrence of the abnormal situation is detected and is not executed before detecting the occurrence of the abnormal situation.

18. The monitoring method according to claim 17, further comprising detecting the occurrence of the abnormal situation based on a sound or heat that is detected by a sensor provided in the monitoring target area.

19. The non-transitory computer-readable medium according to claim 13, wherein the analysis step of analyzing the state of the crowd comprises:
estimating a line of sight of each of people forming the crowd; and
analyzing the number of people whose line of sight is directed to a direction of the occurrence position of the abnormal situation or a ratio of the number of people whose line of sight is directed to a direction of the occurrence position of the abnormal situation to the number of people in the crowd.

20. The non-transitory computer-readable medium according to claim 13, wherein the analysis step of analyzing the state of the crowd comprises:
recognizing a facial expression of each of people forming the crowd; and
analyzing the number of people whose recognized facial expression corresponds to a predetermined facial expression or a ratio of the number of people whose recognized facial expression corresponds to the predetermined facial expression to the number of people in the crowd.

21. The non-transitory computer-readable medium according to claim 13, wherein the occurrence position of the abnormal situation is acquired by estimating a generation source of a sound or heat that is detected by a sensor provided in the monitoring target area.

22. The non-transitory computer-readable medium according to claim 13, wherein the analysis step of analyzing the state of the crowd is executed when the occurrence of the abnormal situation is detected and is not executed before detecting the occurrence of the abnormal situation.

23. The non-transitory computer-readable medium according to claim 22, wherein the program further causes the computer to execute an abnormality detection step of detecting the occurrence of the abnormal situation based on a sound or heat that is detected by a sensor provided in the monitoring target area.
